(19) United States
(12) Patent Application Publication
(10) Pub. No.: US 2016/0002514 A1
(43) Pub. Date: Jan. 7, 2016

(54) STRETCH RELEASABLE ADHESIVE

(71) Applicant: 3M INNOVATIVE PROPERTIES COMPANY, St. Paul, MN (US)

(72) Inventors: Michael D. Determan, Mahtomedi, MN (US); James L. Bries, Cottage Grove, MN (US); Albert I. Everaerts, Oakdale, MN (US); Mark D. Purgett, Oakdale, MN (US); Thu-Van T. Tran, Maplewood, MN (US); Jeffrey O. Emslander, Stillwater, MN (US); Karen J. Calverley, Stillwater, MN (US); Michiko Tachi, Tokyo (JP)

(21) Appl. No.: 14/850,978

(22) Filed: Sep. 11, 2015

Related U.S. Application Data
(62) Division of application No. 12/402,845, filed on Mar. 12, 2009.
(60) Provisional application No. 61/152,099, filed on Feb. 12, 2009.
(60) Provisional application No. 61/036,501, filed on Mar. 14, 2008.
(60) Provisional application No. 61/141,767, filed on Dec. 31, 2008.
(60) Provisional application No. 61/141,795, filed on Dec. 31, 2008.
(60) Provisional application No. 61/141,827, filed on Dec. 31, 2008.

(51) Int. Cl. C09J 183/08; B32B 7/06; C09J 7/02; B32B 7/12

(52) U.S. Cl. CPC C09J 183/08; B32B 7/12; B32B 7/06; C09J 7/0275

(57) ABSTRACT

A stretch releasable adhesive article includes first and second opposed major surfaces and a pull tab, and at least a portion of at least one of the first and second major surfaces is adhesive. The adhesive article has a cross-sectional area—as measured normal to the axis defined by a stretch release force applied to the pull tab during the stretch release process—that has a defined width to thickness ratio, and the adhesive article may have a visible light transmission of at least about 90%, and a haze of no greater than 5%.

### BACKGROUND

The present disclosure relates generally to stretch releasable adhesives that can be used to form releasable bonds between objects and/or substrates. In one aspect, the present disclosure relates to a stretch releasable adhesive article that may be useful in the assembly of optical display devices.

Stretch releasable adhesives are high performance pressure-sensitive adhesives that combine strong holding power with clean removal and no surface damage. Such stretch releasing adhesives are useful in a wide variety of assembling, joining, attaching, and mounting applications.

Stretch releasable adhesives that can be removed from a surface by stretching are known in the patented prior art. U.S. Pat. No. 5,516,581 (Kreckel et al.) discloses a removable adhesive tape having a highly extensible and substantially inelastic backing coated with a layer of pressure sensitive adhesive. U.S. Pat. No. 6,231,962 (Bries et al.) discloses conformable pressure-sensitive adhesive tapes which comprise a layer of polymeric foam in the backing and may be adhered firmly to a substrate and thereafter removed therefrom by stretching at an angle no greater than about 35° from the surface of the substrate. U.S. Pat. No. 7,078,093 (Sheridan et al.) discloses a stretch releasing pressure sensitive adhesive tape including a silicone pressure sensitive adhesive composition that exhibits a 180° peel strength on a glass substrate at 98% relative humidity of at least about 5.47 N/dm, and a non-tacky tab.

U.S. Pat. No. 6,395,389 (Lühmann et al.) discloses an adhesive tape strip for a rereleasable adhesive bond, which can be removed from a bonded joint by pulling in the direction of the bond plane, having a non-adhesive grip tab and a subsequent, elongate strip which is adhesive on one or both sides, characterized in that the strip has a width of 2-6 mm and a ratio of width to thickness of less than or equal to 10:1.

U.S. Patent Publication No. 2007/0059520 (Hatin et al.) discloses a method of removably mounting a touch screen assembly, which includes a glass substrate-based touch screen, to a display panel assembly of a touch screen display system. The method includes providing at least one double-sided, stretch releasable adhesive strip and adhering the strip to the touch screen and the display panel assembly to attach the touch screen to the display panel assembly.

U.S. Patent Publication No. 2004/0191509 (Kishioka et al.) discloses another approach to sticking and fixing a touch panel to a display surface of a display device using a double-sided pressure-sensitive adhesive sheet. One surface of the double-sided pressure-sensitive adhesive sheet is stuck substantially entirely on the touch panel, and the other surface is stuck substantially entirely on the display surface of the display device. The double-sided pressure-sensitive adhesive sheet, which has at least two adhesive layers but does not have a backing layer, is constructed such that it is repeatedly peelable against at least one surface of the touch panel and the display surface of the display device, and has optical isotropy.

### SUMMARY

The need exists for a stretch releasable adhesive for releasably bonding objects and items of various sizes and shapes. More particularly, the need exists for a stretch releasable adhesive article that can be formed into sheets (i.e. broad, thin layers of material) having sizes and/or shapes suitable for various end use applications, and that overcomes the limitations of conventional stretch releasable adhesives. In many end use applications, the adhesive article may be opaque. In other end use applications, it may be desirable that the adhesive article be translucent, clear, or optically clear.

For example, in some end use applications, one of the substrates is an outer surface of an article such as a hook, hanger, clip, holder, organizer, caddy, basket, or sign and the second substrate is a surface to which the article is attached. The second substrate may include, for example, a painted surface, glass, wood (e.g., stained or varnished), porcelain, fiberglass composite, plastic, plaster, concrete, brick, granite, ceramic, marble, stainless steel, or the like. The second substrate may be a wall, window, mirror, cabinet, door, bathroom fixture, vehicle, or the like. In other examples, the first substrate may be signage and the second substrate may be a window or a vehicle.

The adhesive articles may be used in wet or high humidity environments such as those found in bathrooms. For example, they can be adhered to toilets (e.g., toilet tanks), bathtubs, sinks, and walls. The adhesive article may be used in showers, locker rooms, steam rooms, pools, hot tubs, and kitchens (e.g., kitchen sinks, dishwashers and back splash areas, refrigerators and coolers). The adhesive article may also be used in low temperatures applications including outdoor applications and refrigerators. Useful outdoor applications include bonding articles such as signage to outdoor surfaces such as windows, doors and vehicles.

The adhesive articles may be used to mount various items and objects to surfaces such as painted drywall, plaster, concrete, glass, ceramic, fiberglass, metal or plastic. Items that can be mounted include, but are not limited to, wall hangings, organizers, holders, baskets, containers, decorations (e.g., holiday decorations), calendars, posters, dispensers, wire clips, body side molding on vehicles, carrying handles, signage applications such as road signs, vehicle markings, transportation markings, and reflective sheeting.

The adhesive articles may be used to mount items and materials, such as anti-slip matts or anti-fatigue matts, to a floor surface or the bottom of a tub or shower, or to secure items, such as area rugs, to a floor. The adhesive article can be used in various joining and assembling applications including such as adhering at least two containers (e.g., boxes) for later separation. The adhesive article can be used in various cushioning and sound applications such as, for example, cushioning materials for placement beneath objects, sound insulating sheet materials, vibration dampening, and combinations thereof. The adhesive article can be used in various closure applications including container closures (e.g., box closures, closures for food containers, and closures for beverage containers), diaper closures, and surgical drape closures. The adhesive article can be used in various thermal insulation applications. The adhesive article can be used in various sealing applications such as in gaskets for liquids, vapors (e.g., moisture), and dust. The adhesive article can be used in various labels such as removable labels (e.g., notes, price tags, and identification labels on containers), and in signage. The adhesive article can be used in various medical applications (e.g., bandages, wound care, and medical device labeling such as in a hospital setting). The adhesive article can be used in various fastening applications such as fastening one object (e.g., a vase or other fragile object) to another object (e.g., a table or a book shelf). The adhesive article can be used in various securing applications such as fastening one or more components of a locking mechanism to a substrate (e.g., a child safety lock can be adhered to a cabinet or cupboard). The adhesive article can be used in various tamper indicating applications (e.g., tamper indicating articles). The adhesive article can also be incorporated in a variety of other constructions including, but not limited to, abrasive articles (e.g., for sanding), articles for sanding and polishing applications (e.g., buffing pads, disc pads, hand pads, and polishing pads), pavement marking articles, carpeting (e.g., backing for carpeting), and electronic devices (e.g., securing a battery within a housing in a cell phone or PDA (personal digital assistant) to prevent unwanted movement).

The adhesive article (i.e., those in adhesive tapes or single article) can be provided in any useful form including, e.g., tape, strip, sheet (e.g., perforated sheet), label, roll, web, disc, and kit (e.g., an object for mounting and the adhesive tape used to mount the object). Likewise, multiple adhesive articles can be provided in any suitable form including, e.g., tape, strip, sheet (e.g., perforated sheet), label, roll, web, disc, kit, stack, tablet, and combinations thereof in any suitable package including, for example, dispenser, bag, box, and carton.

The need also exists for a stretch release article with desirable optical properties that allow it to be used to affix a substrate, such as an optical lens or cover, to an optical display device, such as a cellular telephone or portable music player (e.g. MP3 players). In such end use applications, it is desirable that the adhesive article be optically clear.

In various aspect, the present invention provides a stretch releasable adhesive article that can be formed into sheets having various sizes and shapes, a stretch releasable adhesive article that is optically clear, and an assembly, such as an optical assembly, including such stretch releasable adhesive articles.

In one embodiment, the present invention provides a stretch releasable adhesive article having first and second opposed major surfaces and a pull tab, wherein at least a portion of at least one of the first and second major surfaces is adhesive, and wherein the adhesive article has a visible light transmission of at least about 90%, and a haze of no greater than 5%.

In another embodiment, the present invention provides a stretch releasable adhesive sheet having first and second opposed major surfaces and a pull tab, wherein at least a portion of at least one of the first and second major surfaces is adhesive, and wherein the adhesive article has a cross-sectional area as measured normal to the axis defined by a stretch release force applied to the pull tab during the stretch release process that has a width to thickness ratio of at least 31:1.

In another embodiment, the present invention provides a stretch releasable adhesive article having first and second opposed major surfaces and a pull tab, wherein at least a portion of at least one of the first and second major surfaces is adhesive, and wherein the adhesive article has a cross-sectional area as measured normal to the axis defined by a stretch release force applied to the pull tab during the stretch release process that has a width to thickness ratio of at least 25:1, and further wherein the adhesive article has a visible light transmission of at least about 90%, and a haze of no greater than 5%.

In another embodiment, the present invention provides a stretch releasable adhesive article comprising an extensible sheet having opposed major surfaces, at least a portion of one major surface being adhesive, wherein the sheet has a cross-sectional area as measured normal to the axis defined by a stretch release force applied to the adhesive article during the stretch release process that has a width to thickness ratio of at least 25:1, and further wherein the adhesive article has a visible light transmission of at least about 80%, and a haze of no greater than 10%.

In other more specific aspects of the above embodiments, the adhesive article may have a width to thickness ratio of at least 35:1, the first and second major surfaces may have an adhesive area of at least about 10 square centimeters, the adhesive article may have a width of at least about 20 mm, the adhesive article may have an average thickness of at least about 25 microns (1 mil) and no greater than about 1300 microns (50 mils), the adhesive article may consist of a single homogeneous layer of adhesive, the adhesive article may consist of a plurality of homogenous layers of adhesive, the adhesive article may include an extensible backing having opposed first and second major surfaces and wherein at least one of the first and second major surfaces includes a layer of pressure sensitive adhesive, the backing layer material may be selected from the group consisting of polyolefins, vinyl copolymers, olefinic copolymers, urethane, acrylic polymers and copolymers, and combinations thereof, and the adhesive may comprise at least one of natural rubber, polyisoprene, polybutadiene, polyurethane, styrene-isoprene-styrene, styrene-butadiene-styrene, acrylic copolymer, acrylic block copolymer, silicone elastomeric polymers, and mixtures thereof.

In another aspect, the present invention provides an assembly comprising a first substrate having a major surface and a perimeter, a continuous stretch releasable adhesive article arranged on substantially all of the first substrate major surface, wherein the stretch releasable adhesive article includes a portion extending beyond the first substrate perimeter, thereby defining a pull tab, and a second substrate arranged on substantially all of the stretch release adhesive article opposite the first substrate, wherein the stretch releasable adhesive article is extensible and has a first major axis defined by the direction of a stretch force applied to the adhesive article during the stretch release process, a length defined along the first major axis, a second major axis transverse to the first major axis, and a width defined along the second major axis, wherein at least a portion of at least one of the first and second major surfaces is adhesive, and wherein the ratio of the adhesive article width to the adhesive article thickness measured in an imaginary plane normal to the first major axis is at least about 15:1.

In other more specific aspects, the assembly may be an optical assembly, the first substrate may be optically clear, the stretch releasable adhesive article may have a visible light transmission of at least about 90%, the stretch releasable adhesive article may have a haze of no greater than about 5%, the stretch releasable adhesive article may have a thickness of at least about 10 microns and no greater than about 300 microns, the stretch releasable adhesive article may include an extensible backing having opposed first and second major surfaces wherein at least one of the first and second major surfaces includes a layer of pressure sensitive adhesive, the backing may be selected from the group consisting of polyolefins, vinyl copolymers, olefinic copolymers, urethanes, acrylic polymers and copolymers, and combinations thereof, the backing may be metallocene catalyzed polyolefin plastomer, the adhesive may comprise at least one of natural rubber, polyisoprene, polybutadiene, polyurethane, styrene-isoprene-styrene, styrene-butadiene-styrene, styrene-ethylene/butylene-styrene, styrene-ethylene/propylene-styrene, acrylic copolymer, acrylic block copolymer, silicone poly urea, and silicone poly oxamide, the adhesive may be a silicone pressure-sensitive adhesive, the first substrate may comprise an electronic display, and the second substrate may comprise at least one of an optical film, a touch panel, and a rigid optically clear lens, and the pull tab may be adhesive or non-adhesive.

The present invention also provides a method of temporarily adhesively bonding a substrate to a liquid crystal display comprising the step of arranging a double-sided stretch releasable adhesive article between the substrate and the liquid crystal display with a portion of the stretch releasable adhesive article extending outwardly from between the substrate and the liquid crystal display, wherein the stretch releasable adhesive article has a visible light transmission of at least about 90%, a haze of no greater than about 5%, and further wherein the stretch releaseable adhesive article is removable from the substrate and liquid crystal display by stretching.

In more specific aspects of the method, the ratio of the adhesive article width to the adhesive article thickness measured in an imaginary plane normal to the first major axis may be at least about 15:1, may have a thickness of at least about 10 microns and no greater than about 300 microns, the stretch releasable adhesive article may include an extensible backing having opposed first and second major surfaces and wherein at least one of the first and second major surfaces includes a layer of pressure sensitive adhesive, the backing may be selected from the group consisting of polyolefins, vinyl copolymers, olefinic copolymers, acrylic polymers and copolymers, and combinations thereof, the backing may be metallocene polyolefin plastomer, the adhesive may comprise at least one of crosslinked acrylic copolymer, acrylic block copolymer, silicone poly urea, and silicone poly oxamide, the adhesive may be a silicone pressure-sensitive adhesive, and the substrate may comprise at least one of an optical film, a touch panel, and a rigid optically clear lens.

Advantage of certain embodiments of the embodiments include that the stretch releasable adhesive article can be formed into sheets having sizes (i.e. surface areas), shapes, and thickness that could not be produced previously, that the stretch releaseable adhesive article is optically clear, and that the adhesive article can be stretch removed without breaking and without leaving adhesive residue.

### BRIEF DESCRIPTION OF THE DRAWINGS

The present invention will be further described with reference to the accompanying drawings, in which:

FIG. 1 is an exploded perspective view of an optical display assembly including a stretch releasable adhesive according to the invention;

FIG. 2 is a perspective view of the stretch releasable adhesive in FIG. 1;

FIG. 3 is a cross-sectional view taken along line 3-3 of FIG. 2; and

FIGS. 4a-h are plan views showing stretch releasing adhesive sheets of different shapes.

### DETAILED DESCRIPTION

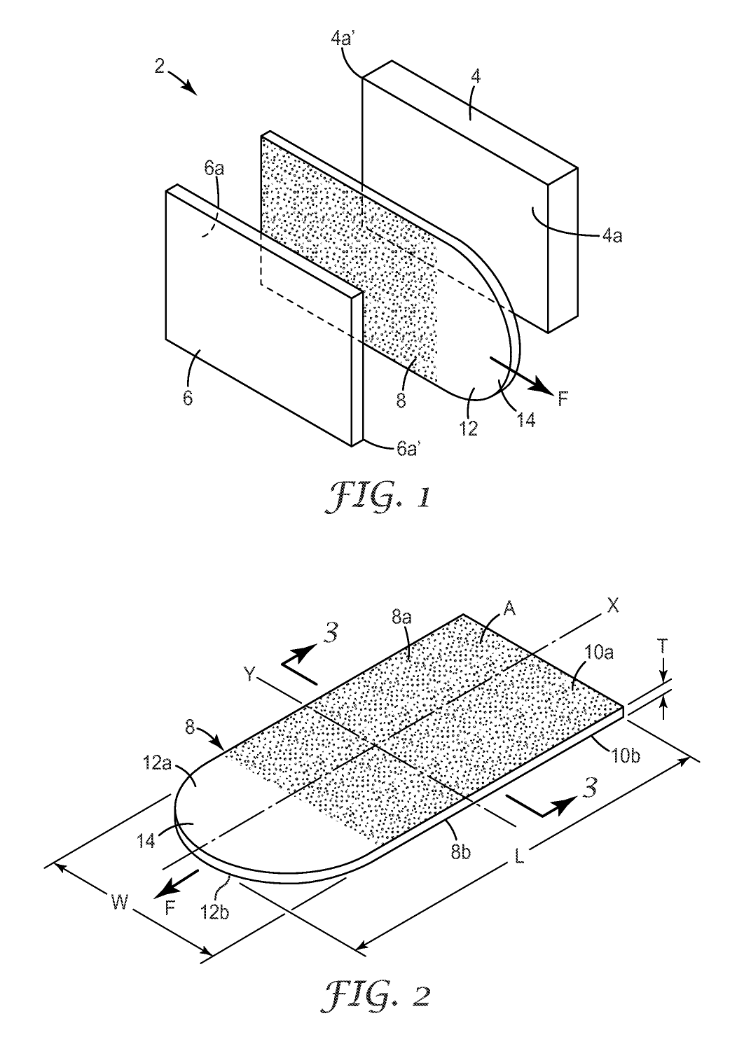

Referring now to the drawings, wherein like reference numerals refer to like or corresponding parts throughout the several views, FIG. 1 is an exploded diagrammatic illustration of an optical display assembly 2 including an electronic display 4, a substrate 6, and a stretch releasable adhesive 8 for releasably bonding the substrate 6 to the electronic display 4. The electronic display 4 may be, for example, a liquid crystal, plasma, or electro wetting display, and the substrate 6 may be, for example, an optical film, touch screen, or a rigid transparent cover made of, for example, polymethyl methacrylate (PMMA) or ordinary glass. The optical display assembly 2 is intended to represent one desirable end use application for the stretch releasable adhesive 8, but it will be recognized that the stretch releasable adhesive 8 may be used in a wide variety of other end use applications.

In the illustrated embodiment, the electronic display 4 has a major surface 4a with a perimeter 4a′ facing the substrate 6, and the substrate 6 has a major surface 6a with a perimeter 6a′ facing the electronic display 4. The stretch releasable adhesive 8 is arranged between the display 4 and substrate 6 major surfaces 4a, 6a, respectively, and overlaps substantially all of the display and substrate major surfaces 4a, 6a. In this manner, the stretch releasable adhesive 8 forms an adhesive bond between substantially all of the major surfaces 4a, 6a of the display 4 and the substrate 6. The stretch releasable adhesive 8 also includes a portion 12 that extends outwardly beyond the perimeter of the display 4 and substrate 6 perimeters 4a′, 6a′, respectively, thereby providing a pull tab 14 that may be manually grasped by a user or, alternatively, mechanically grasped by a tool or device, thereby to stretch the adhesive article 8 during the removal process.

The double-sided stretch releasable adhesive article 8 illustrated in FIG. 1 may be used to form a temporary or releasable adhesive bond between the substrate 6 and the electronic display 4 by arranging the adhesive article 8 between the substrate 6 and the electronic display 4 with a portion 12 of the stretch releasable adhesive article 8 extending outwardly from between the substrate 6 and the electronic display 4, thereby forming a pull tab 14, and placing the respective major surfaces 4a, 6a of the electronic display 4 and substrate 6 into intimate contact with the opposed major surfaces of the adhesive article 8. When separation of the substrate 6 and the electronic display 4 is desired, a stretch force F is applied to the pull tab 14 portion of the adhesive article 8 in the direction shown, thereby causing the adhesive article 8 to sequentially interfacially debond from the respective surfaces of the substrate 6 and electronic display 4. In this manner, if either the substrate 6 or the electronic display 4 are damaged or malfunction during production or use, the substrate 6 and electronic display 4 may be separated and individually repaired and/or replaced rather than discarding the entire optical display assembly 2.

Referring now to FIGS. 2 and 3, the exemplary stretch releasable adhesive article 8 comprises a sheet or strip having first and second opposed major surfaces 8a, 8b, a thickness “T”, a first major axis X defined by the direction of a stretch force F applied to the strip during the stretch release process, a length “L” defined along the first major axis X, a second major axis Y transverse to the first major axis X, and a width “W” defined along the second major axis Y. Each of the first and second opposed major surfaces 8a, 8b includes opposed adhesive regions 10a, 10b, respectively, and opposed non-adhesive regions 12a, 12b, respectively, that define the non-adhesive pull tab 14.

In accordance with a characterizing aspect of the stretch releasable adhesive article 8, the ratio of the article's width W to its average thickness T, as measured in an imaginary plane normal to the first major axis X, may be at least about 25:1, at least about 30:1, at least about 35:1, at least about 40:1, at least about 50, at least about 75, or at least about 100:1. Stated another way, the article 8 has a cross-sectional area (shown in FIG. 3) measured normal to the axis X, which is defined by a stretch release force F applied to the article 8 during the stretch release process, that has a width W to thickness T ratio of at least, for example, about 25:1, about 30:1, at least about 35:1, at least about 40:1, at least about 50:1, at least about 75:1, or at least about 100:1. Thus, in an exemplary embodiment, if the sheet 8 has an average thickness T of about, for example, one (1) millimeter (mm), then the sheet 8 will have a width W of at least about twenty-five (25) mm, at least about thirty (30) mm, at least about thirty-five (35) mm, at least about forty (40) mm, at least about fifty (50) mm, at least about seventy-five (75) mm, or at least about one hundred (100) mm.

In various embodiments, the adhesive article 8 may have a minimum thickness of at least about 1 mil (25 microns), about 2 mils (51 microns), about 3 mils (76 microns), about 4 mils (102 microns), or about 6 mils (152 microns), and a maximum thickness of no greater than about 75 mils (1.9 mm), about 50 mils (1.3 mm), or about 30 mils (0.75 mm). The adhesive article 8 may have a width of at least about 10 mm, at least about 20 mm, at least about 30 mm, at least about 40 mm, at least about 50 mm, at least about 60, or at least about 70 mm.

For certain embodiments, including use in many optical displays, the adhesive regions 10a, 10b of each of the first and second major surfaces 8a, 8b will have a surface area of at least about 5 square centimeters (cm²), at least about 10 cm², at least about 50 cm², or at least about 100 cm². Depending on the particular end use application, the adhesive regions 10a, 10b may have larger surface areas. While in many embodiments, the adhesive article 8 may have any desirable length, in certain embodiments, the adhesive article 8 may have a length L to width W ratio of no greater than about 2:1, no greater than about 1.5:1, or no greater than about 1.25:1.

In another aspect, the adhesive article 8 may have a debond stress as measured according to the Zero Degree Peel Force (Stretch Release Force) test method described in the Examples of at least about 150 pounds per square inch (psi), at least about 175 psi, at least about 200 psi, or at least about 250 psi, and a debond stress of no greater than about 1000 psi, no greater than about 800 psi, or no greater than about 700 psi.

In the embodiment illustrated in FIG. 3, the adhesive article 8 includes an extensible backing layer 16 having opposed first and second major surfaces 16a, 16b respectively, and each of the backing layer 16 first and second major surfaces 16a, 16b includes a layer of pressure sensitive adhesive 18a, 18b, respectively, which define the adhesive regions 10a, 10b. Suitable materials for the backing layer 16 will generally have an elongation at break of about 50% to about 1200%, and will generally have a Young's modulus of about 250 psi to about 5000 psi.

The non-adhesive regions 12a, 12b that define the pull tab 14 may be formed, for example, by not coating these regions of the backing layer 16 with adhesive, or, if coated with adhesive, by detackifying the adhesive regions of the backing layer 16 using known detackification techniques. Alternatively, the adhesive article 8 may consist of a single homogeneous layer of adhesive (i.e. without a backing layer 16) the opposed major surfaces of which may be selectively detackified to form the non-adhesive pull tab 14. While the adhesive article 2 has been described as including a non-adhesive pull tab 14, it will be recognized that the pull tab 14 may be adhesive. Suitable materials for the backing layer 16, as well as suitable adhesive compositions for each of the heretofore described constructions, are set forth below.

The adhesive article 8 may be used in a wide variety of mounting and joining end use applications. The adhesive article 8 may be used, for example, to mount an item or object having a generally planar surface to another item or object having a generally planar surface, or to a generally planer surface, such as a wall or floor. In applications where the adhesive article 8 and the non-adhesive pull tab 14 will be concealed, or in applications where having an inconspicuous non-adhesive pull tab 14 is not important or necessary, the adhesive article 8 may have an opaque pull tab 14. In end use applications where it would be objectionable to have an opaque adhesive article 8 and/or pull tab 14, but where optical clarity is not required, the adhesive article 8 and/or pull tab 14 may be formed to be translucent or visually transparent.

In one desirable end use application, the adhesive article 8 is used in the assembly of optical display devices such as, for example, the display screens of cellular telephones, personal digital assistants, portable media players, LCD televisions, and lap top computers. When used in such end use applications, it is desirable that the adhesive article 8 be sufficiently optically clear so it does not interfere with the use of the device. As such, suitable adhesive articles 8 will generally have a visible light transmission of at least about 88%, at least about 90%, or at least about 91% , and will have a haze of no greater than about 10%, no greater than about 7%, or no greater than about 5% as measured using the method set forth in ASTM D1003-07. In other embodiments where light diffusing characteristics are desirable, the adhesive article 8 may have a visible light transmission of at least about 80%, at least about 83%, or at least about 85%, and will have a haze of at least about 50%, at least about 60%, or at least about 70%.

The adhesive may comprise at least one of tackified rubber adhesives, such as natural rubber, olefins, silicones, polyisoprene, polybutadiene, polyurethanes, styrene-isoprene-styrene and styrene-butadiene-styrene block copolymers, and other elastomers; and tackified or untackified acrylic adhesives such as copolymers of isooctylacrylate and acrylic acid. The adhesive may comprise a single layer or multiple layers of the same or different adhesive compositions. In more specific embodiments, the adhesive may comprise at least one of crosslinked acrylic copolymer, acrylic block copolymer, and silicone elastomeric polymers. Suitable silicone elastomeric polymers include, for example, urea-based silicone copolymers, oxamide-based silicone copolymers, amide-based silicone copolymers, urethane-based silicone copolymers, and mixtures thereof. Such adhesives may be coated onto a backing layer 16 to form the adhesive article 8, or such adhesives may be used to form an adhesive article in the form of a single homogeneous layer of adhesive (i.e. without a backing layer).

The backing layer 16 may be of any suitable construction. For example, the backing layer 16 can be in the form of a foam, a film, or a combination thereof with any suitable thickness, composition, and opaqueness or clarity. The backing layer can be a single layer of film, a single layer of foam, multiple layers of film, multiple layers of foam, or multiple layers of foam and film.

A multiple layer backing construction including, for example, a film layer bonded to a foam layer may be formed using any suitable mechanism including, for example, coextruding the film and the foam layer, co-molding, extrusion coating, joining through an adhesive composition, joining under pressure, joining under heat, and combinations thereof. Useful adhesive compositions for bonding a film layer to the foam layer include the adhesive compositions described herein. Where only one polymeric film or foam layer of a multi-layer backing is intended to be stretched to effect debonding, that layer should exhibit sufficient physical properties, and be of a sufficient thickness, to achieve that objective.

The backing layer 16 for the adhesive article 8 is usually selected to have suitable mechanical properties for use in a stretch release adhesive tape. For example, the backing layer 16 is selected so that it can be stretched (elongated) in a first direction (e.g., a lengthwise direction) at least 50 percent without breaking. That is, at least one dimension such as the length of the backing layer can be increased through stretching at least 50 percent without breaking. In some embodiments, the backing layer 16 can be stretched at least 100 percent, at least 150 percent, at least 200 percent, at least 300 percent, at least 400 percent, or at least 500 percent without breaking. The backing layer 16 can often be stretched up to 1200 percent, up to 1000 percent, up to 800 percent, up to 750 percent, or up to 700 percent without breaking. These relatively large elongation values facilitate stretch releasing of the adhesive article 8 after being adhered to an object and/or substrate.

The Young's Modulus of the backing layer can be an indicator of the resistance of the backing layer to stretching. In certain embodiments, the Young's modulus of the backing layer may be no greater than 75,000 psi (about 520 MPa), no greater than about 50,000 psi (about 345 MPa), no greater than 25,000 psi (about 170 MPa), no greater than 10,000 psi (about 70 MPa), no greater than 5,000 psi (about 3.4 MPa), no greater than 1,000 psi (about 7 MPa), or no greater than 500 psi (about 3.4 MPa). For some film backing layers such as those described below that contain a poly(alkylene) copolymer, the Young's Modulus is often in the range of about 10 MPa to about 75 MPa. For example, the Young's Modulus can be in the range of 20 to 75 MPa, in the range of 20 to 60 MPa, in the range of 20 to 50 MPa, or in the range of 25 to 50 MPa. The Young's Modulus can be measured, for example, using method ASTM D790-07 or ASTM D882-02.

In many applications, the foam or film backing layers are prepared from a polymeric material such as, for example, a polyolefin (e.g., polyethylene such as high density polyethylene, low density polyethylene, linear low density polyethylene, and linear ultra low density polyethylene, polypropylene, and polybutylene), vinyl copolymers (e.g., polyvinyl chloride and polyvinyl acetates), olefinic copolymers (e.g., ethylene/methylacrylate copolymers, ethylene/vinyl acetate copolymers, and ethylene/propylene copolymers), acrylonitrile-butadiene-styrene copolymers, acrylic polymers and copolymers, polyurethanes, and combinations or blends thereof. Exemplary blends include polypropylene/polyethylene blends, polyurethane/polyolefin blends, polyurethane/polycarbonate blends, and polyurethane/polyester blends. Other suitable blends may include, for example, blends of thermoplastic polymers, elastomeric polymers and combinations thereof. Suitable blends can include, for example, styrene-butadiene copolymers, polychloroprenes (i.e., neoprene), nitrile rubbers, butyl rubbers, polysulfide rubbers, cis-1,4-polyisoprenes, ethylene-propylene terpolymers (e.g., EPDM rubber), silicone rubbers, silicone polyurea block copolymers, polyurethane rubbers, natural rubbers, acrylate rubbers, thermoplastic rubbers (e.g., styrene-butadiene block copolymers, styrene-isoprene-styrene block copolymers, styrene-ethylene/butylene-styrene block copolymers, styrene-ethylene/propylene-styrene block copolymers), thermoplastic polyolefin rubber materials, and combinations thereof.

In some embodiments, the backing layer 16 is a film that contains a poly(alkylene) copolymer that is derived from at least two different alkene monomers. The poly(alkylene) copolymer is typically the reaction product of an alkene mixture that includes 1) a first alkene selected from ethene, propene, or a mixture thereof and 2) a second alkene monomer selected from a 1,2-alkene having 4 to 8 carbon atoms. For example, the second alkene monomer often has four, six, or eight carbon atoms. That is, the alkene mixture includes 1) ethene, propene, or a mixture thereof and 2) butene, hexene, octene, or a mixture thereof. These copolymers are typically prepared using a metallocene catalyst. Mixtures or combinations of these copolymers may also be used.

A useful foam backing layer is typically conformable and assists in increasing the degree of surface contact between the pressure-sensitive adhesive layer disposed thereon and the surface of the substrate. The foam layer preferably is capable of achieving from about 50 percent to about 600 percent elongation (i.e., the foam layer is stretchable at least 50 percent to 600 percent). The elongation at break is preferably sufficiently high so that the backing layer remains intact during removal of the adhesive tape from a substrate to which it has been adhered.

The foam backing layers are often selected to optimize properties such as conformability and resiliency. Conformable and resilient polymeric foams are well suited for applications in which the adhesive article is to be adhered to substrates having surface irregularities. The foam layer usually has a density of at least about 2 pounds per cubic foot (pcf), at least about 6 pcf, at least about 8 pcf, or at least about 12 pcf, less than about 30 pcf, less than about 25 pcf, or even less than about 15 pcf. The foam layer can have any thickness suitable for the intended application. Suitable foam backing layers often have a thickness of at least 5 mils or at least 30 mils. The thickness can be up to 100 mils, up to 125 mils, up to 150 mils, or even greater. In some embodiments the foam layer includes multiple layers of foam and each layer of foam contributes a different property such as density, percent elongation, tensile strength, and combinations thereof.

Examples of useful polymeric backing materials for stretch releasing pressure-sensitive adhesive assemblies are disclosed in U.S. Pat. No. 5,516,581 and PCT Application No. WO 95/06691, the entire contents of which are hereby incorporated by reference. Useful polyethylene vinyl acetate copolymer foams are available under the VOLEXTRA and VOLARA series of trade designations from Voltek, Division of Sekisui America Corporation, Lawrence, Mass.

Polymeric film backing layers can be in a variety of forms including, for example, a single-layer or multi-layer film, a porous film, and combinations thereof. The polymeric film may contain one or more fillers (e.g., calcium carbonate). The polymer film can be a continuous layer or a discontinuous layer. Multi-layer polymer films are preferably integrally bonded to one another in the form of a composite film, a laminate film, and combinations thereof. Multilayer polymeric films can be prepared using any suitable method including, for example, co-molding, coextruding, extrusion coating, joining through an adhesive, joining under pressure, joining under heat, and combinations thereof.

A film layer of a backing can be bonded to a layer of foam using any suitable mechanism including, for example, coextruding the film and the foam layer, co-molding, extrusion coating, joining through an adhesive composition, joining under pressure, joining under heat, and combinations thereof. Any suitable adhesive compositions for bonding a film layer to the foam layer can be used. Where only one polymeric film or foam layer of a multi-layer backing is intended to be stretched to effect debonding, that layer should exhibit sufficient physical properties and be of a sufficient thickness to achieve that objective.

In embodiments where the backing layer 16 includes at least a foam layer and a film layer, the film layer may contain a poly(alkylene) copolymer that is derived from at least two different alkene monomers. The poly(alkylene) copolymer is typically the reaction product of an alkene mixture that includes 1) a first alkene selected from ethene, propene, or a mixture thereof and 2) a second alkene monomer selected from a 1,2-alkene having 4 to 8 carbon atoms. For example, the second alkene monomer often has four, six, or eight carbon atoms. That is, the alkene mixture includes 1) ethene, propene, or a mixture thereof and 2) butene, hexane, octane, or a mixture thereof. These copolymers are typically prepared using a metallocene catalyst. Mixtures or combinations of these copolymers may also be used.

Other suitable adhesive article constructions including adhesive compositions and backing materials are disclosed in U.S. patent application Ser. No. 12/811,973 (claiming priority of Provisional Patent Application No. 61/020,423), Ser. No. 12/919,806 (claiming priority of Provisional Patent Application No. 61/036,501), Ser. No. 13/142,004 (claiming priority to Provisional Patent Application No. 61/141,767), Ser. No. 13/132,145 (claiming priority to Provisional Patent Application No. 61/141,795), and Ser. No. 13/142,329 (claiming priority to Provisional Patent Application No. 61/141,827), the entire contents of which are hereby incorporated by reference.

In some applications, the backing layers (if present), the adhesive layers, and the resulting stretch releasable adhesive article are optically clear. As used herein, the term “optically clear” refers to a backing layer, an adhesive layer, or an adhesive article that has a luminous transmission of at least 85 percent and a haze no greater than 5 percent as measured using the method ASTM D1003-07. With this method, measurements are made in the 400 to 700 nanometer wavelength range. The luminous transmission is often equal to at least 91 percent, at least 92 percent, at least 93 percent, at least 94 percent, or least 95 percent. The haze is often no greater than 4, no greater than 3, no greater than 2, or no greater than 1. Some exemplary adhesive articles 8 have a haze no greater than 3 percent and a luminous transmission equal to at least 90 percent as measured using method ASTM D1003-07. Other exemplary adhesive articles 8 have a haze no greater than 2 percent and a luminous transmission equal to at least 90 percent as measured using method ASTM D1003-07. Not all materials that are visibly clear are considered to be optically clear. That is, visible clarity is not always synonymous with optical clarity. A material that is visibly clear can have a haze value greater than 5, a luminous transmission value less than 85 percent, or both.

In some end use applications, the optically clear, stretch releasable adhesive article can be positioned between two substrates such that the second substrate is visible when viewed through both the first substrate and the optically clear adhesive article. If the adhesive article is optically clear, the second substrate often can be viewed by looking through the first substrate and the adhesive article. The optically clear adhesive article may be used to couple a first substrate such as an optically clear substrate (e.g., a cover lens) to a second substrate such as a display (e.g., a liquid crystal display). If the adhesive coupling formed by the adhesive article is adequate, the optically clear adhesive article remains positioned between the first substrate and the display. If the coupling is defective, however, or if the one of the substrate or display is damaged and a user wishes to separate the substrate from the display, the adhesive article can be removed from the substrate and display, without damaging either, by stretching. The adhesive article 8 can then be replaced, and the first substrate and the display can be coupled again with another optically clear, stretch releasable adhesive article.

Optically clear backing layers are used to prepare optically clear adhesive tapes. In many embodiments, the optically clear backing layers contain poly(alkylene) copolymers prepared from an alkene mixture that includes 1) a first alkene selected from ethene, propene, or a mixture thereof and 2) a second alkene monomer selected from a 1,2-alkene having 4 to 8 carbon atoms. Many poly(alkylene) copolymers with suitable mechanical properties for use as a backing layer, however, do not have low haze (i.e., no greater than 5 percent as measured using method ASTM D1003-07) and high luminous transmission (i.e., at least 90 luminous transmission as measured using ASTM D1003-07) that is usually needed to prepare an optically clear backing layer for use in an optically clear adhesive tape. For example, the relatively large crystalline size of many poly(alkylene) copolymers, the use of various additives in many commercially available poly(alkylene) copolymers, and the specific methods used to form films of the poly(alkylene) copolymer can make then unsuitable for use as an optically clear backing layer.

If an optically clear backing is desired, the poly(alkylene) copolymer preferably has some crystalline material rather than being completely amorphous. The crystalline material tends to add strength to the backing layer by functioning as a physical crosslinker. If the size of the crystalline material is too large, however, the haze of the backing layer can be unacceptably large. The crystalline material preferably has a size that is less than a wavelength of visible light. In many embodiments of suitable poly(alkylene) copolymers, at least 95 percent of the crystalline material has a crystalline size less than 400 nanometers. For example, at least 95 percent of the crystalline material can have a crystalline size less than 300 nanometers, less than 200 nanometers, or less than 100 nanometers. A small crystalline size facilitates the formation of a backing layer that is optically clear.

Backing layers with crystalline material smaller than 400 nanometers can be prepared using various methods. In one method, the poly(alkylene) copolymers used to form the backing layer are melted, extruded, and quenched rapidly so that the alignment and growth of the crystals is minimized. In another method, seed materials (i.e., nucleating agents) can be added that facilitate the formation of many crystals within the copolymer upon cooling to form the solidified film. The formation of more crystals tends to favor smaller crystalline sizes. In yet another method, the copolymer composition is varied to alter the crystalline size. A greater amount of the second alkene monomer having 4 to 8 carbon atoms tends to result in smaller crystalline size. The density or specific gravity tends to decrease as the amount of the second alkene monomer increases. The specific gravity is often no greater than 0.91. For example, the specific gravity is often no greater than 0.90 or no greater than 0.89. The specific gravity is often in the range of 0.86 to 0.91, in the range of 0.87 to 0.90, or in the range of 0.88 to 0.90.

If optical clarity is desired, the backing layer 16 preferably is free or substantially free of additives that contribute haze or that lower the luminous transmission. For example, the backing layer typically does not include an anti-blocking agent, a slip agent, or both. That is, the backing layer 16 is usually free or substantially free of an anti-blocking agent, slip agent, or both. As used herein, the term “substantially free” with reference to the anti-blocking agent or to the slip agent means that these agents are each present in an amount no greater than 0.5 weight percent, no greater than 0.3 weight percent, no greater than 0.2 weight percent, no greater than 0.1 weight percent, no greater than 0.05 weight percent, or no greater than 0.01 weight percent. Anti-blocking agents are often added when films are prepared from poly(alkylene) copolymers to prevent the film from sticking to itself such as when formed into a roll. Exemplary anti-blocking agents include, but are not limited to, particles such as diatomaceous earth and talc. Slip agents are often added to reduce friction such as film-to-film friction in a roll or film-to-production equipment friction. The presence of these slip agents also can interfere with good adhesion to the at least one pressure-sensitive adhesive layer. Many commonly used slip agents are primary amides such as those made from long chain fatty acids by amidation. Examples of slip agents include, but are not limited to, stearamide, oleamide, and erucamide.

In many embodiments where optical clarity is desired, the backing layer contains at least 99 percent poly(alkylene) copolymer. For example, the backing layer contains at least 99.1 weight percent, at least 99.2 weight percent, at least 99.3 weight percent, at least 99.4 weight percent, at least 99.5 weight percent, at least 99.6 weight percent, at least 99.7 weight percent, at least 99.8 weight percent, at least 99.9 weight percent poly(alkylene) copolymer.

Exemplary poly(alkylene) copolymers that can be used to prepare optically clear backing layers are commercially available under the trade designation EXACT (e.g., EXACT 3024, 3040, 4011, 4151, 5181, and 8210) and VISTAMAXX (e.g., VISTAMAXX 6202 and 3000) from ExxonMobile Chemical (Houston, Tex.). Other exemplary poly(alkylene) copolymers are commercially available under the trade designations AFFINITY (e.g., AFFINITY PT 1845G, PL 1845G, PF 1140G, PL 1850G, and PL 1880G), ENGAGE (e.g., ENGAGE 8003), and INFUSE (e.g., INFUSE D9530.05) from Dow Chemical (Midland, Mich.). EXACT 0210, EXACT 8210, EXACT 5181, ENGAGE 8003, and INFUSE D9530.05, are ethylene-octene copolymers. EXACT 3040 and EXACT 4151 are ethylene-hexene copolymers. EXACT 3024 and EXACT 4011 are ethylene-butene copolymers.

Exemplary film backing layers formed from poly(alkylene) copolymers that are not optically clear are available under the trade designations XMAX and MAXILENE series of trade designations (e.g., MAXILENE 200 is an ethylene-octene copolymer that is not prepared with a metallocene catalyst) from Pliant Corporation (Chippewa Falls, Wis.). These backing layers can be used to produce adhesive tapes that are visibly clear but not optically clear, slightly hazy, or opaque. These films often contain a slip agent, an anti-blocking agent, or both.

In addition to choosing suitable materials that will result in backing layers with low haze and high luminous transmission, the method of preparing the backing layer must be selected to maintain these values if optical clarity is desired. That is, the method of making the backing layer is typically selected to provide a smooth surface and a relatively uniform thickness. If the surface is roughened, the percent haze may become undesirably large. To provide suitable optical clarity, a process is often selected to provide a thickness that is relatively uniform across the backing layer in any direction. For example, the thickness varies by less than 10 percent, less than 8 percent, less than 6 percent, less than 5 percent across the backing layer in any direction. More specifically, a backing layer having an average thickness of 4 mils (0.1 millimeter or 100 micrometers) has a thickness variation of less than 10 micrometers, less than 8 micrometers, less than 6 micrometers, or less than 5 micrometers across the backing layer in any direction.

If optically clear backing layers are desired, many conventional methods used to form films of poly(alkylene) copolymers are not suitable because the resulting films do not have the requisite smoothness. For example, blowing methods are usually not suitable because anti-blocking agents or slip agents are frequently added. The addition of these agents often tends to roughen the surface of the resulting film. Cast extrusion methods that impart a rough surface to the film in an attempt to minimize contact with a chill roller are typically not suitable. These methods can be used, however, to prepare backing layers when optical clarity is not a concern.

Various methods can be used to prepare backing layers with suitable smoothness and thickness uniformity when optical clarity is desired. In a first example, the poly(alkylene) copolymer can be cast between two smooth support layers such as release liners or between a smooth support layer and a smooth roller. No blocking agent or slip agent is needed and the absence of these agents is preferred. The support layer (e.g., release liner) tends to reinforce the resulting rubbery backing layer and allows the backing layer to be subjected to further processing without distortion or stretching. Further, the support layer tends to protect the surface of the backing layer until it is combined with the at least one pressure-sensitive adhesive layer.

More specifically, the poly(alkylene) copolymer can be extruded as a molten film using, for example, a flat cast extrusion die. The extrusion temperature can be in the range of about 150° C. to 275° C. The extruded film of poly(alkylene) copolymer can be extruded between two support films. The resulting construction of support film/poly(alkylene) copolymer film/support film can then be passed through a chilled roll stack to cool and solidify the poly(alkylene) copolymer film. Backing films that are prepared using this method tend to have a relatively uniform thickness and tend to be relatively smooth. The support films are often release liners. Suitable support films, such as conventional PET film or release liners, may be used during the preparation of the backing film layer. The support films are typically easily removed after preparation of the backing layer without stretching or damaging the backing film layer.

The thickness of a film-based backing layer is often selected by balancing the desired load bearing strength and rupture strength against the stretch release force. A greater stretch release force is usually needed as the thickness of the backing layer is increased. Conversely, a lower stretch release forces is needed as the thickness of the backing layer is decreased. The thickness of a film-based backing layer can be, for example, up to 40 mils (1.0 millimeter or 1000 micrometers). As used herein, the term “mil” refers to 0.001 inch and 1 mil is equal to about 0.0025 centimeters or about 0.025 millimeters or about 25 micrometers. In many embodiments, the thickness is up to 30 mils (750 micrometers), up to 20 mils (500 micrometers), up to 10 mils (250 micrometers), up to 8 mils (200 micrometers), up to 6 mils (150 micrometers), or up to 5 mils (125 micrometers). The thickness is often at least 1 mil (0.025 millimeters or 25 micrometers), at least 2 mils (50 micrometers), at least 3 mils (75 micrometers), or at least 4 mils (100 micrometers). Some suitable backing layers have a thickness in the range of 1 mil (25 micrometers) to 20 mils (500 micrometers), in the range of 1 mil (25 micrometers) to 10 mils (250 micrometers), in the range of 1 mil (25 micrometers) to 8 mils (200 micrometers), in the range of 1 mil (25 micrometers) to 7 mils (175 micrometers), in the range of 2 mils (50 micrometers) to 8 mils (200 micrometers), in the range of 3 mils (75 micrometers) to 6 mils (150 micrometers), or in the range of 4 mils (100 micrometers) to 5 mils (125 micrometers).

As prepared, the backing layer is usually a rubbery material and can be slightly tacky. A pressure-sensitive adhesive layer is positioned adjacent to at least one major surface of the backing layer. In many embodiments, a first pressure-sensitive adhesive layer is positioned adjacent to a first major surface of the backing layer and a second pressure-sensitive adhesive layer is positioned adjacent to a second major surface of the backing layer. The second major surface of the backing layer is the surface opposite the first major surface. As used herein, the term “adjacent” with reference to the pressure-sensitive adhesive layer and the backing layer means that the pressure-sensitive adhesive layer contacts the backing layer or is separated from the backing layer by one or more intervening layers. That is, each pressure-sensitive adhesive layer is adhered directly or indirectly to the backing layer. The intervening layer is often a primer layer or a layer resulting from a priming treatment.

The backing layer 16 may be subjected to a priming treatment prior to being positioned adjacent to the at least one pressure-sensitive adhesive layer. The primer treatment tends to increase adhesion between the backing layer and the pressure-sensitive adhesive layer. This increased adhesion is often desirable for a stretch releasing adhesive tape. That is, it is usually desirable that the adhesion of the pressure-sensitive adhesive layer to the backing layer is stronger than the adhesion of the pressure-sensitive adhesive layer to the substrate. Any suitable priming treatment known in the art can be used. For example, the priming treatment can include treatment with a chemical primer composition, treatment with a corona discharge or plasma discharge, exposure to an electron beam or ultraviolet light, acid etching, or combinations thereof.

In some embodiments, the primer treatment includes applying a primer composition to a surface of the backing layer. Any suitable primer composition can be used. The primer composition can include, for example, a reactive chemical adhesive promoter (e.g., the components can react with the backing layer, the adhesive layer, or both). Exemplary primer compositions include those described in U.S. Pat. No. 5,677,376 (Groves), incorporated herein by reference in its entirety. That is, the primer composition can include a blend of (1) a block copolymer such as styrene-ethylene/butylene-styrene block copolymer that is modified with maleic acid or maleic anhydride and (2) the polymeric reaction product of monovalent monomer mixture that includes (a) at least one alkyl (meth)acrylate ester of a non-tertiary alcohol having 1 to 14 carbon atoms and (b) at least one nitrogen-containing monomer. The block copolymer can be, for example, those commercially available from Shell Chemical Co. under the trade designation KRATON FG-1901X. Other suitable primer compositions include those commercially available under the trade designation NEOREZ (NEOREZ R551) from DSM NeoResins+, Wilmington, Mass. This primer composition contains waterborne polyurethane.

In a specific embodiment useful in the assembly of optical display devices, the adhesive article 8 is a double-sided adhesive sheet or strip including a backing layer 16 having opposed regions 10a, 10b coated with adhesive, and non-adhesive regions 12a, 12b that define a pull tab 14. The strip has an average overall thickness (i.e. the combination of the backing layer and adhesive layers) of at least about 25 microns, at least about 50 microns, or at least about 75 microns, an average overall thickness of no greater than about 750 microns, no greater than about 350 microns, and no greater than about 250 microns, a width of at least about 2 centimeter (cm), at least about 2.5 cm, and at least about 3 cm, and no greater than about 70 cm, no greater than about 60 cm, and no greater than about 50 cm, an adhesive surface area of about 5 cm² to about 2500 cm², a debond stress of about 50 Newtons/square centimeter (N/cm²) to about 500 N/cm², the backing is formed of metallocene polyolefin plastomer, and the adhesive is a silicone pressure-sensitive adhesive.

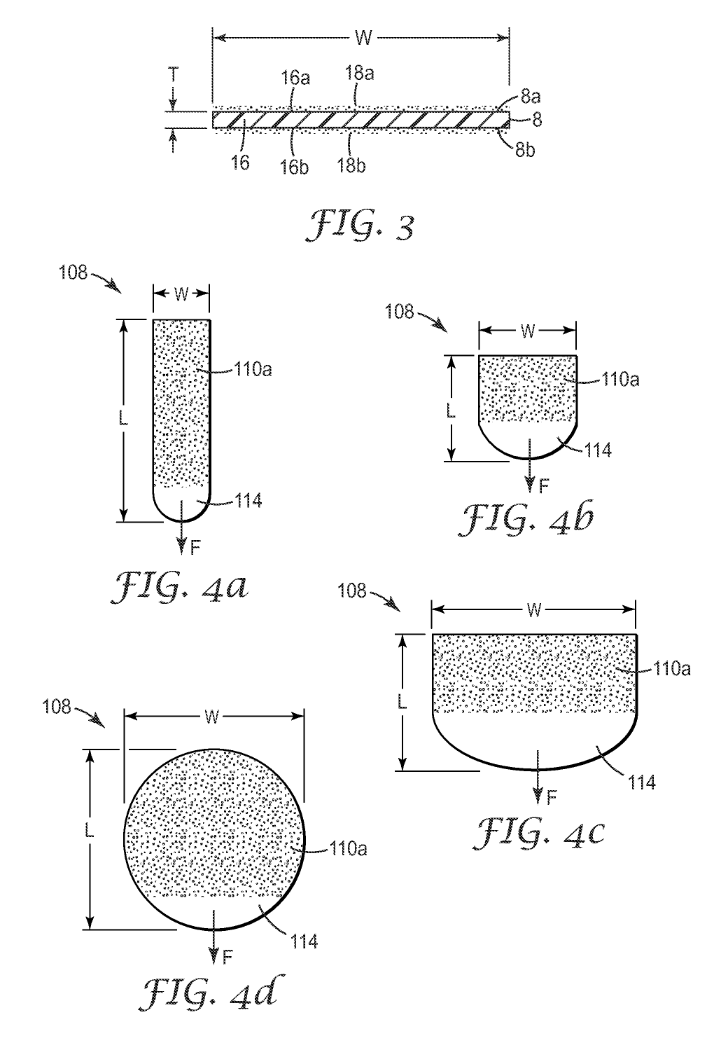

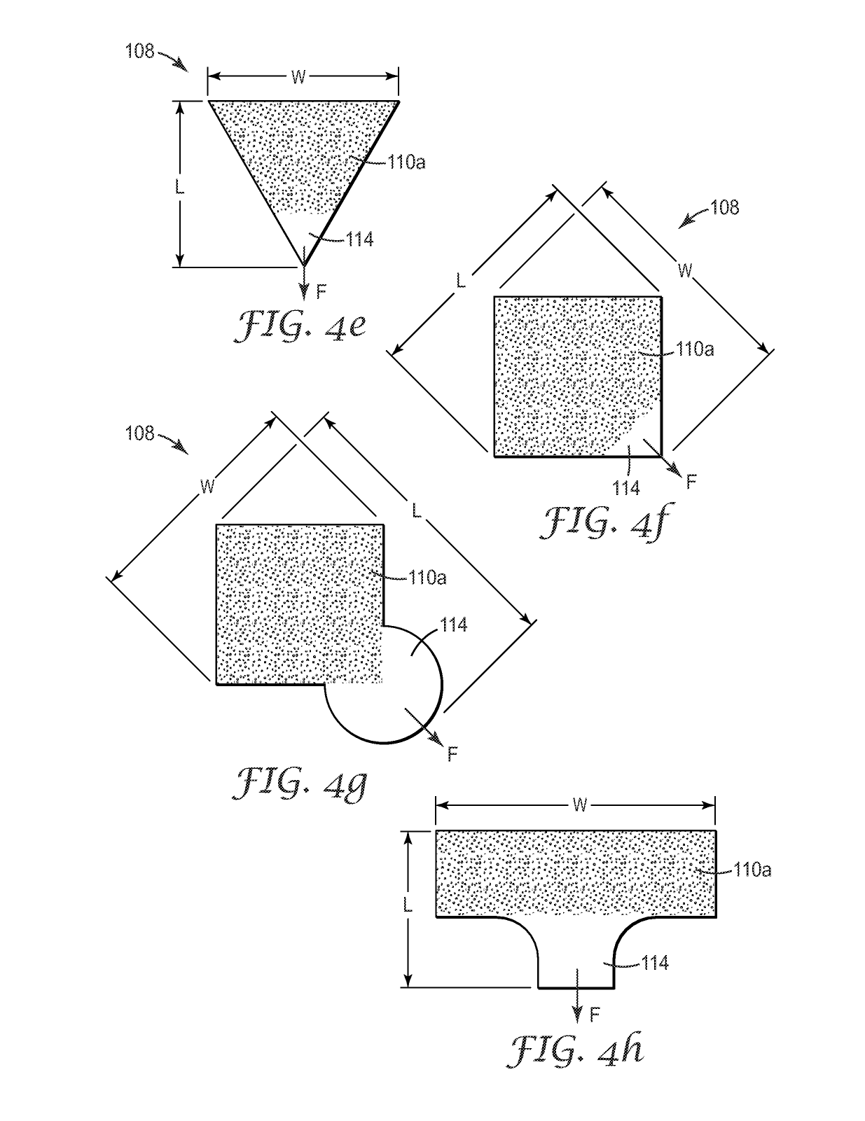

FIGS. 4a-h, show a variety of exemplary adhesive articles 108 having selected shapes. Each of the adhesive articles 108 includes an adhesive region 110a, a non-adhesive pull tab 114, and is stretch removable from one or more surfaces to which it has been bonded by applying a stretch force F to the pull tab 114 in the direction shown. The embodiments shown in FIGS. 4a-h are intended to represent a small sampling of the wide variety of possible shapes.

FIGS. 4a-c show three adhesive articles 108 having different length L to width W ratios, wherein the width of the adhesive region 110a generally corresponds to the width of the pull tab 114. The adhesive article 108 in FIG. 4a has a L:W ratio greater than 1, the adhesive article 108 in FIG. 4b has a L:W ratio of about 1, and the adhesive article 108 in FIG. 4c has a L:W ratio of less than 1.

The adhesive article 108 in FIG. 4d is circular, and has a L:W ratio of about 1. The adhesive article 108 in FIG. 4e is triangular and has a L:W ratio of about 1. In FIG. 4f, the adhesive article is generally square shaped and has a L:W ratio of about 1. In each of FIGS. 4d, 4e, and 4f, the non-adhesive pull tab 114 occupies an edge region of the basic geometric shape of the adhesive article 108 (i.e. circle, triangle, or square), and each adhesive article 108 has an adhesive region 110a having a width that varies along the length L of the article 108.

In FIG. 4g, the adhesive article includes a generally square shaped adhesive region 110a, and a generally circular shaped pull tab 114 that extends outwardly from one corner of the adhesive region. FIG. 4h shows an adhesive article 108 having a relatively wide adhesive region 110a that tapers down to a narrower width that forms the pull tab 114. In FIGS. 4g and 4h, the width of the adhesive regions 110a is generally greater than the width of the pull tab 114.

In order that the invention described herein can be more fully understood, the following examples are set forth. It should be understood that these examples are for illustrative purposes only, and are not to be construed as limiting this invention in any manner.

### EXAMPLES

### Test Methods

### Zero Degree Peel Force (Stretch Release Force)

Adhesive tape samples with adhesive on both sides of a backing layer were placed between two glass plates leaving a pull tab protruding from one end of the resulting assembly. The assembly was rolled twice with a 4.5 kilogram roller to firmly bond the adhesive tape to the two glass substrates. For Examples 1-14, the length of the sample between the glass plates was 1.75 inches, and for Examples 15-23, the length of the sample between the glass plates was 1.5 inches. The adhesive was allowed to dwell on the substrates for at least 15 minutes. The assembly was mounted in a tensile testing machine so that the substrates were gripped in the lower (fixed) jaws and the pull tab was clamped in the upper (crosshead) jaws. The tab was pulled at 0 degrees relative to the adhered surfaces of the substrates and stretched to release (i.e. separate or decouple) the substrates. A 12 inch per minute crosshead speed was used. The average debond stress and average debond force required to effect release by stretching was recorded.

### Haze and Visible Light Transmission

Haze and luminous transmittance were determined using a Gardner BYK Color TCS Plus model 8870 spectrophotometer from BYK Gardner, (Columbia, Md.) as described in ASTM Method 1003-07. CIE Standard Illuminant A was used. To prepare the samples for haze and luminous transmittance measurements, one liner was removed from the adhesive sample and the adhesive sample was hand laminated to a 1 mil thick polyester film that is commercially available from DuPont (Wilmington, Del.) under the trade designation MELINEX. Care was taken to avoid trapped air bubbles between adhesive and film. A 75×50 mm microscope glass slide (Plain Micro Slide, Dow Corning) was cleaned three times with isopropanol and dried with TEXWIPE 309 (Texwipe Company, N.Y.). The second release liner was removed from the adhesive sample and the adhesive sample was then laminate to the glass slide using a hand roller. The sample was inspected to ensure that no dust or air bubbles were trapped in the laminated test specimen. The thickness of the test samples, percent haze and percent luminous transmittance were recorded.

### Method of Measuring Thickness

The thickness of a sample was measured using an Ono Soki ST-022 digital gauge. Multiple measurements were taken at random locations across the sample and the average thickness was recorded in units of inches (in).

### Materials

### SYL-OFF Q2-7785 Release Liner

The SYL-OFF Q2-7785 (Loparex, Willowbrook, Ill.) release liner is a 35 pound bleached Kraft paper sandwiched between two 11.5 pound high density polyethylene corona treated film layers one of which includes a matte finish and the other of which includes a gloss finish. The exposed surface of the matte finish polyethylene film layer includes approximately 2.5 grams per square meter (gsm) of the reaction product of Q2-7786 fluorosilicone polymer (Dow Corning Corp., Midland, Mich.), Q2-7560 crosslinking agent (Dow Corning Corp.) and platinum-based catalyst (Dow Corning Corp.) and the exposed surface of the gloss finish polyethylene film layer includes approximately 1.5 gsm of the reaction product of Q2-7785 fluorosilicone polymer (Dow Corning Corp.), Q2-7560 crosslinking agent and platinum catalyst.

### Film Backing 1: EXACT 5181

A film of EXACT 5181 (ExxonMobile Chemical Company, Houston, Tex.), was prepared in a 0.75 inch Brabender laboratory extruder with a mixing screw. After melting and mixing, the extrudate was forced through a 12 inch flat cast extrusion die to form a molten film. The temperatures within the extruder were 160° C. (zone 1), 180° C. (zone 2), 190° C. (zone 3), 190° C. (adapter), and 190° C. (die) respectively. The molten film was then laminated on each side with a 2 mil untreated PET film. The resulting laminate (PET/molten polymer/PET) was passed through a chilled roll stack to cool and solidify the EXACT 5181 copolymer into a solidified film. The line speed was adjusted to produce a solidified film with a thickness of approximately 5 mils (127 microns).

### Film Backing 2: Vistamaxx 6102

A film of Vistamaxx 6102 was prepared in a 0.75 inch Brabender laboratory extruder with a mixing screw. After melting and mixing, the extrudate was forced through a 6 inch flat cast extrusion die to form a molten film. The temperatures within the extruder were 160° C. (zone 1), 180° C. (zone 2), 190° C. (zone 3), 190° C. (adapter), and 190° C. (die) respectively. The molten film was then laminated on each side with a 2 mil untreated PET film. The resulting laminate (PET/molten polymer/PET) was passed through a chilled roll stack to cool and solidify the Vistamaxx 6102 copolymer into a solidified film. The line speed was adjusted to produce a solidified film with a thickness of approximately 4 mils (100 microns).

### Film Backing 3: EXACT 0210

A film of EXACT 0210 was prepared in a 0.75 inch Brabender laboratory extruder with a mixing screw. After melting and mixing, the extrudate was forced through a 6 inch flat cast extrusion die to form a molten film. The temperatures within the extruder were 160° C. (zone 1), 180° C. (zone 2), 190° C. (zone 3), 190° C. (adapter), and 190° C. (die) respectively. The molten film was then laminated on each side with a 2 mil untreated PET film. The resulting laminate (PET/molten polymer/PET) was passed through a chilled roll stack to cool and solidify the EXACT 0210 copolymer into a solidified film. The line speed was adjusted to produce a solidified film with a thickness of approximately 4 mils (100 microns).

### Film Backing 4: EXACT 8210

A film of EXACT 8210 was prepared in a 0.75 inch Brabender laboratory extruder with a mixing screw. After melting and mixing, the extrudate was forced through a 6 inch flat cast extrusion die to form a molten film. The temperatures within the extruder were 160° C. (zone 1), 180° C. (zone 2), 190° C. (zone 3), 190° C. (adapter), and 190° C. (die) respectively. The molten film was then laminated on each side with a 2 mil untreated PET film. The resulting laminate (PET/molten polymer/PET) was passed through a chilled roll stack to cool and solidify the EXACT 8210 copolymer into a solidified film. The line speed was adjusted to produce a solidified film with a thickness of approximately 4 mils (100 microns).

### Composite Foam Backing 5

A 36 mil thick multi-layer composite foam laminate backing included a polyethylene vinyl acetate copolymer foam layer having a density of 6 pounds per cubic foot laminated between two pieces of 0.0046 cm (1.80 mil) thick linear low-density polyethylene film. The film layers of the composite foam laminate were treated with a chemical primer prepared according to Example 15 of U.S. Pat. No. 5,677,376 (Groves) prior to adhesive lamination.

### Preparation of the Pressure-Sensitive Adhesive Compositions

### Pressure-Sensitive Adhesive Composition 1 (PSA1)

A pressure-sensitive adhesive composition was prepared according to the method of Example 27 of U.S. Patent No. 6,569,521 (Sheridan), the entire contents of which are incorporated herein by reference, with the exception that the amount of each component was altered to achieve a pressure-sensitive adhesive composition with MW PDMS diamine (/1000)/moles Dytek A polyamine/% by weight MQ resin of 33/0.5/50.

Pressure-sensitive adhesive composition 1 was coated on the SYL-OFF Q2-7785 treated surface of a SYL-OFF Q2-7785 release liner using a laboratory knife coater. The adhesive was then dried in a forced air oven at 70° C. for approximately 15 minutes to yield a dry coating of the pressure-sensitive adhesive. For Examples 1-7 the dry adhesive thickness was about 2.5 mils. For Examples 15-25 the dry adhesive thickness was about 1.5 mils. For Examples 30-34 the dry adhesive thickness was about 3.0 mils.

### Pressure-Sensitive Adhesive Composition 2 (PSA2)

A pressure-sensitive adhesive composition was prepared by combining 2546 g DC Q2-7066 MQ resin (62.7% solids in toluene), 7300 g toluene and 1306 g of a silicone polyoxamide elastomer derived from a 25,000 weight average molecular weight α,ω-bis(aminopropyl)polydimethylsiloxane diamine. The elastomer was made in two steps. In step 1 a 25,000 molecular weight α,ω-bis(aminopropyl)polydimethylsiloxane diamine was capped with diethyloxalate following general laboratory procedures as detailed in Preparative Example 1 in U.S. Pat. No. 7,371,464 to provide a precursor. The diethyloxalate is used in a molar excess to the diamine to provide the α,ω-oxamido oxalate ester capped precursor. This precursor was chain-extended into the elastomer using ethylenediamine following general laboratory procedures as detailed in Preparative Example 3 in U.S. Pat. No. 7,371,464 with the exception that only the precursor from step 1 (described above) was used instead a mixture of precursors and the reaction time was four days. The mole ratio of precursor to ethylenediamine was 1 to 1. The material was used neat without determining the hardness.

The polyoxamide elastomer and MQ resin were mixed on a roller mill until the silicone polyoxamide polymer was dissolved (overnight). This adhesive contained 45 weight percent silicone polyoxamide elastomer and 55 weight percent MQ resin and final percent solids of the solution was 26.

Pressure-sensitive adhesive composition 2 was coated on the SYL-OFF Q2-7785 treated surface of a SYL-OFF Q2-7785 release liner using a laboratory knife coater. The adhesive was then dried in a force air oven at 70° C. for approximately 15 minutes to yield a dry coating of the pressure-sensitive adhesive. The dry adhesive thickness was about 2.5 mils.

### Pressure-Sensitive Adhesive Composition 3 (PSA3)

A pressure-sensitive adhesive composition was prepared according to the method of Example 27 of U.S. Pat. No. 6,569,521 (Sheridan), the entire contents of which are incorporated herein by reference, with the exception that the amount of each component was altered to achieve a pressure-sensitive adhesive composition with MW PDMS diamine (/1000)/moles Dytek A polyamine/% by weight MQ resin of 33/0.5/58.

Pressure-sensitive adhesive composition 3 was coated on the SYL-OFF Q2-7785 treated surface of a SYL-OFF Q2-7785 release liner using a laboratory knife coater. The adhesive was then dried in a force air oven at 70° C. for approximately 15 minutes to yield a dry coating of the pressure-sensitive adhesive. The dry adhesive thickness was about 7.0 mils.

### Examples 1-7

The adhesive layers of pressure-sensitive adhesive composition 1 were laminated onto Film Backing 1 prepared from EXACT 5181. Lamination was carried out at room temperature by transfer laminating the adhesive film to each side of the air corona treated EXACT 5181 film using 25 psi lamination pressure. The resulting optically clear adhesive tape (Adhesive Composition 1—Film Backing 1—Adhesive Composition 1) was subsequently die-cut to produce test samples (Examples 1-7). The samples were tested and the results are shown in Table 1.

TABLE 1

| Example | 1 | 2 | 3 | 4 | 5 | 6 | 7 |
|---|---|---|---|---|---|---|---|
| Width to | 42 | 58 | 77 | 96 | 115 | 154 | 231 |
| thickness ratio | | | | | | | |
| Adhesive surface | 0.88 | 1.31 | 1.75 | 2.19 | 2.63 | 3.50 | 5.25 |
| area (square | | | | | | | |
| inches) | | | | | | | |
| Width (in.) | 0.50 | 0.75 | 1.00 | 1.25 | 1.50 | 2.00 | 3.00 |
| Average | 0.012 | 0.013 | 0.013 | 0.013 | 0.013 | 0.013 | 0.013 |
| thickness (in.) | | | | | | | |
| Debond Stress | 490 | 518 | 490 | 459 | 468 | 479 | 448 |
| (psi) | | | | | | | |
| Debond force | 3.0 | 5.1 | 6.4 | 7.5 | 9.1 | 12.4 | 17.5 |
| (lb) | | | | | | | |

VLT/Haze

### Examples 8-14

The adhesive layers of pressure-sensitive adhesive composition 2 were laminated onto Film Backing 1 prepared from EXACT 5181. Lamination was carried out at room temperature by transfer laminating the adhesive film to each side of the air corona treated EXACT 5181 film using 25 psi lamination pressure. The resulting optically clear adhesive tape (Adhesive Composition 2—Film Backing 1—Adhesive Composition 2) was subsequently die-cut to produce test samples (Examples 8-14). The samples were tested and the results are shown in Table 2.

TABLE 2

| Example | 8 | 9 | 10 | 11 | 12 | 13 | 14 |
|---|---|---|---|---|---|---|---|
| Width to | 50 | 75 | 100 | 125 | 150 | 200 | 300 |
| thickness ratio | | | | | | | |
| Adhesive surface | 0.88 | 1.31 | 1.75 | 2.19 | 2.63 | 3.50 | 5.25 |
| area (square | | | | | | | |
| inches) | | | | | | | |
| Width (in.) | 0.50 | 0.75 | 1.00 | 1.25 | 1.50 | 2.00 | 3.00 |
| Average | 0.010 | 0.010 | 0.010 | 0.010 | 0.010 | 0.010 | 0.010 |
| thickness (in.) | | | | | | | |
| Debond Stress | 654 | 653 | 685 | 680 | 698 | 607 | 590 |
| (psi) | | | | | | | |
| Debond force | 3.27 | 4.90 | 6.85 | 8.51 | 10.47 | 11.55 | 17.70 |
| (lb) | | | | | | | |

VLT/Haze

### Examples 15-17

The adhesive layers of pressure-sensitive adhesive composition 1 were laminated onto Film Backing 2 prepared from VISTAMAXX 6102. Lamination was carried out at room temperature by transfer laminating the adhesive film to each side of the air corona treated VISTAMAXX 6102 film using 25 psi lamination pressure. The resulting optically clear adhesive tape (Adhesive Composition 1—Film Backing 2—Adhesive Composition 1) was subsequently cut to produce test samples (Examples 15-17) The samples were tested and the results are shown in Table 3.

TABLE 3

| Example | 15 | 16 | 17 |
|---|---|---|---|
| Width to thickness ratio | 71 | 107 | 143 |
| Adhesive surface area (square inches) | 0.88 | 1.31 | 1.75 |
| Width (in.) | 0.50 | 0.75 | 1.00 |
| Average thickness (in.) | 0.007 | 0.007 | 0.007 |
| Debond Stress (psi) | 347 | 331 | 321 |
| Debond force (lb) | 1.2 | 1.7 | 2.25 |

| | |
|---|---|
| VLT/Haze | VLT = 92.4% |
| | Haze = 0.64 |

### Examples 18-20

The adhesive layers of pressure-sensitive adhesive composition 1 were laminated onto Film Backing 3 prepared from EXACT 0210. Lamination was carried out at room temperature by transfer laminating the adhesive film to each side of the air corona treated EXACT 0210 film using 25 psi lamination pressure. The resulting optically clear adhesive tape (Adhesive Composition 1—Film Backing 3—Adhesive Composition 1) was subsequently cut to produce test samples (Examples 18-20). The samples were tested and the results are shown in Table 4.

TABLE 4

| Example | 18 | 19 | 20 |
|---|---|---|---|
| Width to thickness ratio | 71 | 107 | 143 |
| Adhesive surface area (square inches) | 0.88 | 1.31 | 1.75 |
| Width (in.) | 0.50 | 0.75 | 1.00 |
| Average thickness (in.) | 0.007 | 0.007 | 0.007 |
| Debond Stress (psi) | 594 | 614 | 664 |
| Debond force (lb) | 2.1 | 3.2 | 4.6 |

| | |
|---|---|
| VLT/Haze | VLT = 92.1 |
| | Haze = 0.55 |

### Examples 21-24

The adhesive layers of pressure-sensitive adhesive composition 1 were laminated onto Film Backing 4 prepared from EXACT 8210. Lamination was carried out at room temperature by transfer laminating the adhesive film to each side of the air corona treated EXACT 8210 film using 25 psi lamination pressure. The resulting optically clear adhesive tape (Adhesive Composition 1—Film Backing 4—Adhesive Composition 1) was subsequently cut to produce test samples (Examples 21-24). The samples were tested and the results are shown in Table 5.

TABLE 5

| Example | 21 | 22 | 23 | 24 |
|---|---|---|---|---|
| Width to thickness | 15 | 71 | 107 | 143 |
| ratio | | | | |
| Adhesive surface | 0.19 | 0.88 | 1.31 | 1.75 |
| area (square inches) | | | | |
| Width (in.) | 0.11 | 0.50 | 0.75 | 1.00 |
| Average thickness | 0.007 | 0.007 | 0.007 | 0.007 |
| (in.) | | | | |
| Debond Stress (psi) | 491 | 511 | 524 | 503 |
| Debond force (lb) | 0.4 | 1.8 | 2.8 | 3.5 |

| | |
|---|---|
| VLT/Haze | VLT = 92.5 |
| | Haze = 0.50 |

### Examples 25-29

Adhesive composition 3 was prepared as described above. The adhesive itself was used to produce the stretch release adhesive samples, (i.e. the samples had a solid adhesive construction, and did not include a backing layer). The optically clear adhesive (i.e. Adhesive Composition 3) was cut to produce the test samples (Examples 25-29). The samples were tested, and the results are shown in Table 6.

TABLE 6

| Example | 25 | 26 | 27 | 28 | 29 |
|---|---|---|---|---|---|
| Width to | 16 | 36 | 71 | 107 | 143 |
| thickness | | | | | |
| ratio | | | | | |
| Adhesive | 0.19 | 0.44 | 0.88 | 1.31 | 1.75 |
| surface | | | | | |
| area (square | | | | | |
| inches) | | | | | |
| Width (in.) | 0.11 | 0.25 | 0.50 | 0.75 | 1.00 |
| Average | 0.007 | 0.007 | 0.007 | 0.007 | 0.007 |
| thickness | | | | | |
| (in.) | | | | | |
| Debond | 223 | 213 | 211 | 193 | 195 |
| Stress (psi) | | | | | |
| Debond | 0.2 | 0.4 | 0.7 | 1.0 | 1.4 |
| force (lb) | | | | | |

| | |
|---|---|
| VLT/Haze | VLT = 93.5 |
| | Haze = 0.30 |

### Examples 30-34

Adhesive layers of pressure-sensitive adhesive composition 1 were laminated onto Composite Foam Backing 5. Lamination was carried out at room temperature by transfer laminating the adhesive film to each side of the chemical primed composite foam using 25 psi lamination pressure. The resulting adhesive tape (Adhesive Composition 1—Composite Foam Backing 5—Adhesive Composition 1) was subsequently die-cut to produce test samples (Examples 30-34). The samples were tested and the results are shown in Table 7.

TABLE 7

| Example | 30 | 31 | 32 | 33 | 34 |
|---|---|---|---|---|---|
| Width to | 18 | 24 | 35 | 47 | 71 |
| thickness | | | | | |
| ratio | | | | | |
| Adhesive | 1.31 | 1.75 | 2.63 | 3.50 | 5.25 |
| surface | | | | | |
| area (square | | | | | |
| inches) | | | | | |
| Width (in.) | 0.75 | 1.00 | 1.50 | 2.00 | 3.00 |
| Average | 0.0423 | 0.0423 | 0.0423 | 0.0423 | 0.0423 |
| thickness | | | | | |
| (in.) | | | | | |
| Debond | 201 | 197 | 189 | 187 | 172 |
| Stress (psi) | | | | | |
| Debond | 6.4 | 8.3 | 12.0 | 15.8 | 21.8 |
| force (lb) | | | | | |
| VLT/Haze | | | | | |

For each example, when the test samples were stretch released as described above in the Zero Degree Peel Force test, each adhesive article sample released from both of the glass microscope slide substrates without breaking, and without leaving adhesive residue.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures.

What is claimed is:

1. A stretch releasable adhesive article, comprising:
an extensible backing having opposed first and second major surfaces; the extensible backing including a poly(alkylene) copolymer;
a pressure sensitive adhesive on at least a portion of at least one of the first or second major surfaces; the pressure sensitive adhesive including at least one of a silicone or an styrene-butadiene-styrene or blends thereof;
a pull tab;
wherein the stretch releasable adhesive article has a visible light transmission of at least about 80%; and
wherein the stretch releasable adhesive article has a width to thickness ratio of at least 25:1.

2. The stretch releasable adhesive article of claim 1, wherein the stretch releasable adhesive article has a haze of no greater than 10%.

3. The stretch releasable adhesive article of claim 1, wherein the stretch releasable adhesive article has a haze of no greater than 8%.

4. The stretch releasable adhesive article of claim 1, wherein the pressure sensitive adhesive is on at least a portion of the first and second major surfaces.

5. The stretch releasable adhesive article of claim 1, wherein the backing includes multiple layers.

6. The stretch releasable adhesive article of claim 1, wherein the backing includes at least one of a foam or a polymeric film.

7. The stretch releasable adhesive article of claim 6, wherein the foam has a density of at least 2 pounds per cubic foot and less than about 30 pounds per cubic foot.

8. The stretch releasable adhesive article of claim 1, wherein the stretch releasable adhesive article has a width to thickness ratio of at least 30:1.

9. The stretch releasable adhesive article of claim 1, wherein the stretch releasable adhesive article has a minimum thickness of at least about 1 mil and a maximum thickness of no greater than 75 mils.

10. The stretch releasable adhesive article of claim 1, wherein the stretch releasable adhesive article has a debond stress of at least about 150 psi according to the Zero Degree Peel Force test.

11. The stretch releasable adhesive article of claim 1, wherein the stretch releasable adhesive article has a visible light transmission of at least about 83%.

12. The stretch releasable adhesive article of claim 1, wherein the stretch releasable adhesive article has a visible light transmission of at least 85%.

13. The stretch releasable adhesive article of claim 1, wherein the backing includes at least 99 weight percent poly(alkylene) copolymer.

14. The stretch releasable adhesive article of claim 1, wherein the backing has a thickness that varies by less than 10% across the backing in any direction.

15. The stretch releasable adhesive article of claim 1, wherein the backing layer is substantially free of each of a blocking agent and a slip agent.

16. The stretch releasable adhesive article of claim 1, wherein at least one dimension of the stretch releasable adhesive article can be increased through stretching by at least 50 percent without breaking.

17. The stretch releasable adhesive article of claim 1, wherein at least one dimension of the stretch releasable adhesive article can be increased through stretching at least 500 percent without breaking.

18. The stretch releasable adhesive article of claim 1, wherein the backing has a Young's modulus of no greater than 520 MPa.

19. The stretch releasable adhesive article of claim 1, wherein the backing has a Young's modulus of between about 10 MPa and about 75 MPa.

20. The stretch releasable adhesive article of claim 1, wherein the backing has a tensile strength at break of at least about 4,300 psi.

21. The stretch releasable adhesive article of claim 20, wherein the tensile strength at break is at least about 5,300 psi.

22. The stretch releasable adhesive article of claim 20, wherein the tensile strength at break is at least about 6,300 psi.

23. The stretch releasable adhesive article of claim 1, wherein the silicone elastomeric polymer is at least one of urea-based silicone copolymers, oxamide-based silicone copolymers, amide-based silicone copolymers, urethane-based silicone copolymers, and mixtures thereof.

24. The stretch releasable adhesive article of claim 1, wherein the poly(alkylene) copolymer is at least one of an ethylene-based butane plastomer, an ethylene-based hexane copolymer, an ethylene-based hexane plastomer, an ethylene-based hexane plastomer, and/or an ethylene octane copolymer.

25. The stretch releasable adhesive article of claim 1, wherein the stretch releasable adhesive article is optically clear.

26. The stretch releasable adhesive article of claim 1, wherein the stretch releasable adhesive article is configured to be positioned between a first optically clear substrate and a second substrate such that the second substrate is visible when viewed through both the first substrate and the stretch releasable adhesive article.

27. The stretch releasable adhesive article of claim 26, wherein the stretch releasable adhesive article is adhered to a substrate and the substrate is at least one of a wall hanging, an organizer, a holder, a basket, a container, a decoration, a calendar, a poster, a dispenser, a wire clip, a body side molding on a vehicle, a carrying handle, a signage application, a road sign, a vehicle marking, a transportation marking, reflective sheeting, a hook, a hanger, a clip, a caddy, a sign, a toilets, a bathtub, a sink, an anti-fatigue mat, an anti-slip mats, a removable layer, a box closure, a closures for a food container, a closures for a beverage containers, a diaper closure, and/or a surgical drape closure.

28. The stretch releasable adhesive article of claim 1, wherein the stretch releasable adhesive article is at least one of a tape, a strip, a sheet, a perforated sheet, a label, a roll, a web, a disc, a kit, a stack, a tablet, and a combinations thereof.

29. The stretch releasable adhesive article of claim 1, wherein the adhesive article can be used to mount an object.
